(19) United States
(12) Patent Application Publication
(10) Pub. No.: US 2020/0214270 A1
(43) Pub. Date: Jul. 9, 2020

(54) Raised Feeder Guard

(71) Applicant: Arturo Cavazos, Weslaco, TX (US)

(72) Inventor: Arturo Cavazos, Weslaco, TX (US)

(21) Appl. No.: 16/240,724

(22) Filed: Jan. 5, 2019

(51) Int. Cl. A01K 39/01; A01K 39/012

(52) U.S. Cl. CPC A01K 39/0113; A01K 39/012

(57) ABSTRACT

The present disclosure describes a novel guard used to protect an electronic feeder on a raised feed bin by partially enclosing the feeder. In some implementations, the guard is at least partially constructed of expanded steel. In some implementations described herein, the guard is further protected from the elements by a coating. The disclosure describes how the novel guard in some implementations comprises mounting brackets that are used to attach the guard to the underside of the feed bin in a position that partially encloses the feeder. The invention prevents varmints from accessing the feed and feeder distribution components, thus preventing feed waste and consumption by varmints such as raccoons. Yet, the guard does not obstruct or impede access to the programmable timing unit and other control mechanisms of the feeder.

### CROSS-REFERENCE TO RELATED APPLICATIONS

This application does not claim the benefit of provisional patent.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Many people use feeders to feed animals. Among the various feeder systems, the raised feeder is particularly popular. Raised feeders typically feature a 55-gallon drum as the feed bin, which is positioned on top of a tripod, having a distributor mounted to the bottom of the feed bin. The feed bin acts like a storage hopper that keeps the feed protected from the elements and animals. The distributor is typically an electrical motor with a rotating distributer plate that causes the feed coming out of the bottom of the feed bin to be cast radially around the base of the tripod. Often the distributor system includes a programable timing unit, electric motor, and battery in a weather proof housing. Some distributor units further include wiring and a solar panel to replenish and maintain the battery charge.

An advantageous feature of the raised feeder is that the stand elevates the feed bin (aka the hopper) and allows for gravity assisted feed flow to the distributor. But by far the biggest advantage over unraised-feeders is that the elevated feeder is more difficult for animals to reach, preventing unintended access to the feed and other components. Unintended access is a significant issue that plagues many feeder owners. Raccoons and other vermin are frequently observed climbing the stand legs or climbing over one another to reach the feed distributors. Once in reach, the animals hang from the feed distributors while manually rotating the distributer plate or other feed distribution mechanism.

Some deterrents and security measures on the market include sharp spikes and other anti-climbing measures on the stand legs. While some feed distributor units have an electrified wire that surrounds the feed distributor. However, these types of products have several drawbacks that have prevented widespread use or adoption. In the case of both anti-climbing measures and electrified barriers, these are undesired because they apply indiscriminately, which may deter the target game. This can be bad for attracting the intended game or livestock. Additionally, electrical barriers cause significantly increased battery depletion leading to feeder failure that requires battery replacement. The increased feeder down-time and required maintenance is not an insignificant hassle. In many cases, these feeders are positioned in remote areas that are not frequently visited by the owner, which means that many days or weeks may go by before the problem is discovered and resolved.

All of these failings in the prior art further add to the need and desire for a better feeder security solution.

There are simple cages designed as a one size fits all solution. The idea is that different brands and models of feed distributors come in different shapes and sizes. The simple cage design attempts to encompass and encase the entire feed distributor unit. However, the prior art cages seen in the market have at least two main failings that have rendered them cumbersome and useless—or else utterly ineffective for the intended purpose—because they are designed based on a few key industry beliefs that the present disclosure debunks.

Prior art cages are cumbersome. The various cages of the prior art fully enclose the entire feed distributor. But of course, the cage prevents access to the programming controls and the battery unit. To ameliorate the problem that the prior art security solutions created, the cages of the prior art either use reversible mounting hardware or have doors built into them. Both work arounds create vulnerabilities that are readily exploited by wildlife. In particular, raccoons are often the crafty villains seen in game-camera video recordings shared online. Raccoons and other vermin have figured out how to pull, hang, twist, bite, and bend the prior art cages until the reversibly connectable hardware used to mount the cages to the underside of the feed bin snaps, breaks, or comes loose. The same tactics also work on the hinges and latches used to attach and close the cage doors. The present invention once attached does not need to be removed and does not have doors—yet still allows the user to readily access the feed distributor unit.

Prior art cages use large openings (also called rail spacing, diamonds, or clear distance, depending on the type of cage or fencing used). However, these large openings are known to be exploited by animals to access the feed distributor. Raccoon arms and smaller vermin easily pass through the large openings. The reason these are not made smaller is that the various cages of the prior art operate on the widely accepted belief in the industry that large openings are a necessity. The idea is that larger openings provide less restriction to the casting of the feed. Casting means the physical ejection of the feed. Feed casting is prioritized because it is believed to be more attractive and accessible to the intended feed recipient animals—such as grazing deer. Additionally, the concern is that an overly restrictive opening would become blocked with feed that is unable to pass through it, resulting in wasted feed, prevented broadcast of feed, and additional cleaning maintenance. The present invention unconventionally goes against those design principals. Yet as the inventor has discovered, there is an optimal range much smaller than previously contemplated by the prior art that allows feed to pass and yet blocks vermin without an observable decrease in target animal feeding or an increase in feed clog related maintenance.

### BRIEF SUMMARY

The present invention is a simple yet unconventional guard that does one thing incredibly well—that is protecting feed distributors from animal tampering without causing harm to animals and without encumbering the distributor unit. The novel features allow for the simplification of the overall structure. The simplicity in form improves the resistance to animal tampering. It also makes for a stronger, more weather resistant, and highly durable product.

In short, it is a goal of the present invention to provide a novel cage or feeder guard that addresses the problems of the prior art discussed in the Background section above by adding a large opening in the guard that is customized to the feeder distributor unit housing. In some implementations, the guard features a small opening sized diamond grill formed of strong expanded metal. There are no moving parts, hinges, latches, or other vulnerabilities for animals to exploit. Since the feeder distributor housing passes through the guard, it can still be readily accessed for changes, repairs, programming, maintenance, etc. Because of this, stronger means of attachment can be used to secure the guard to the feeder bin—unlike prior art cages which must be removed each time the user requires access to the feeder distributor.

Additional features, goals, and advantages of this invention will be readily understood from the following descriptions, drawings, and claims.

### BRIEF DESCRIPTION OF THE SEVERAL VIEWS OF THE DRAWING

FIG. 1 shows a perspective view of a basic embodiment of the invention.

### DETAILED DESCRIPTION OF THE DISCLOSURE

The invention disclosed herein will be described according to various embodiments to illustrate particular features and functionality. Since this invention is particularly well suited for the raised feeder, it is worth noting here the basic parts typical of the raised feeder. The typical raised feeder comprises a stand having three or more legs, a feed bin positioned atop the stand, feed loaded into the feed bin, and a distributor unit mounted to the bottom of the feed bin. Furthermore, it is worth noting here the basic parts typical of the distributor unit. A typical distributor unit comprises an electric motor, a power source such as a battery, a distributor plate (sometimes called a blade or wheel), a programmable timing unit, and a weather resistant housing that protects the programable timing unit and other sensitive parts such as electronic components and the battery.

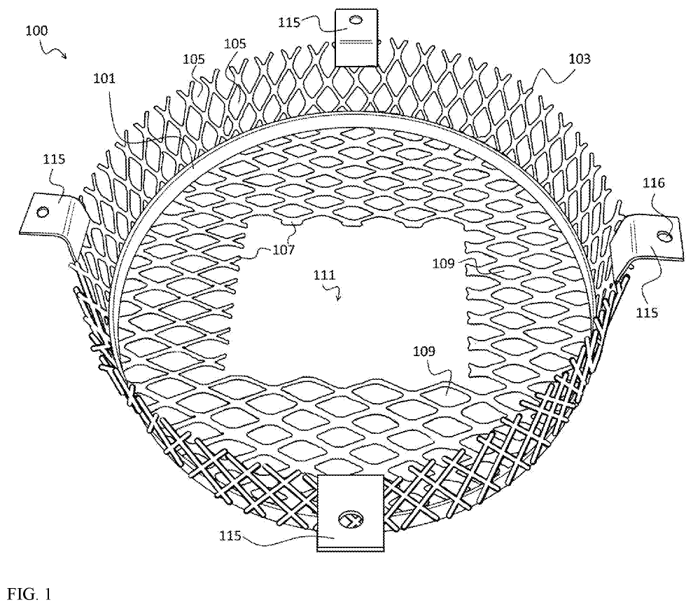

Referring to FIG. 1 a first implementation, guard 100, is shown. Guard 100 includes a ring 101 which provides mechanical support (strengthens and stiffens the guard). Ring 101 also establishes the bottom perimeter of the guard. In guard 100, ring 101 has the shape of a cylindrical hoop with an inner and outer diameter for simplicity in depicting and understanding the invention. However, upon reading the present disclosure it will be appreciated by those having ordinary skill in the art that the shape could be substituted with a variety of other regular and irregular shapes without departing from the present invention. For example, in place of a cylindrical loop, the ring 101 could take the form of a polygon or a curved complex shape.

Still referring to guard 100, there is a sidewall 103 connected to ring 101. The sidewall 103 is attached to the exterior edge of ring 101 in guard 100, but upon reading the present disclosure it will be appreciated by those having ordinary skill in the art that the relative position can be changed without departing from the present disclosure. For example, the sidewall 103 may be connected to the interior edge of ring 101. In guard 100, sidewall 103 has the shape of a cylinder with a height, an inner diameter, and an outer diameter for simplicity in depicting and understanding the invention. The dimensions of sidewall 103 are adapted for the target feeder upon which guard 100 will be applied. For example, if the target feeder has a housing having a total height of twelve inches, wherein the bottom four inches are removable for the purpose of accessing the programing buttons (feeder controls)—then the sidewall 103 height may be set at less than eight inches to accommodate the user during removal of the removable portion of the feeder housing. Sidewall 103 has a plurality of feed openings 105 that are of sufficient size to allow feed to pass through while preventing entrance by varmints or their appendages.

Again, referring to guard 100, there is a bottom-wall 107 connected to ring 101. The bottom-wall 107 is attached to the bottom edge of ring 101 in guard 100, but upon reading the present disclosure it will be appreciated by those having ordinary skill in the art that the relative position can be changed without departing from the present disclosure. For example, the bottom-wall 107 may be connected to the interior edge of ring 101. In guard 100, bottom-wall 107 has the shape of a circle with an outer diameter for simplicity in depicting and understanding the invention. The shape and dimensions of bottom-wall 107 are adapted for the ring 101. Preferentially, the bottom-wall 107 is circle shaped and has a diameter that is less than the outer diameter of the feed bin. For the commonly used 55-gallon drum used as a feed bin, those implementations of the present invention should preferentially not exceed approximately 23 inches.

The bottom-wall of the presently disclosed guard has two types of openings: a plurality of feed openings and a feeder housing opening. Referring again to FIG. 1, the plurality of feed openings 109 of bottom-wall 107 are similar to the plurality of feed openings 105 of sidewall 103 in that they are of sufficient size to allow feed to pass through while preventing entrance by varmints or their appendages. The feeder housing opening 111 is adapted for the target feeder upon which guard 100 will be applied. For example, if the target feeder has a housing having a square perimeter having an edge length of five inches—then the opening 111 will have a square shape with dimensions greater than five inches to accommodate the feeder housing. The feeder housing opening 111 is preferentially centered with respect to the bottom-wall 107.

Guard 100 further comprises a means of attachment to the target feeder structure. It is most common for feeders to be directly attached to the bottom of feed bins. For that reason, the bottom of the feed bin is a convenient and sturdy site to attach the guard of the present invention. Still referencing FIG. 1, guard 100 further comprises mounting brackets 115. In guard 100, mounting brackets 115 are attached to sidewall 103, but upon reading the present disclosure it will be appreciated by those having ordinary skill in the art that the relative position can be changed without departing from the present disclosure. For example, the mounting brackets 115 may be connected directly to ring 101. In FIG. 1, guard 100 is depicted as having four mounting brackets 115 positioned evenly around the diameter of sidewall 103, however, fewer or more mounting brackets 115 may be used as appropriate or desired. At least one is necessary, though three to four are preferred. The mounting brackets 115 use fasteners 117 to connect to the feeder bin. There are many well-known methods of attachment and many well know fastener types that would be readily apparent to one having ordinary skill in the art. Each may be a suitable replacement or substitution for the other, or there may be inherent advantages to one method of attachment and fastener type depending on the situation. For example, screws, nuts & bolts, self-anchoring bolts, nails, glue, rivets, and the like could be used, though self-tapping screws are preferred fasteners 117 for the present invention. In implementations such as guard 100, fasteners 117 partially pass through and engage with mounting brackets 115 via fastener hole 116.

As those having ordinary skill and knowledge in the field of feeders will attest, feeders come in a variety of shapes and sizes, though there are ranges of dimensions that include most products. Though guard 100 has a feeder housing opening 111 that is sized specifically for the target feeder, some other implementations further comprise at least one adjustment plate 113. The adjustment plate is used to adjust the size of the feeder housing opening 111 to accommodate a smaller feeder housing. Some implementations utilize a single plate, while others comprise more than one adjustment plate. In some related implementations, the adjustment plates 113 consist of two generally “L” shaped plates that are positioned opposite one another around the feeder housing opening 111. These plates are positioned against and secured to the bottom-wall 107 with adjustment plate fasteners 114. There are many well-known methods of attachment and many well know fastener types that would be readily apparent to one having ordinary skill in the art. Each may be a suitable replacement or substitution for the other, or there may be inherent advantages to one method of attachment and fastener type depending on the situation. For example, screws, toggles, nails, glue, rivets, and the like could be used, though simple nuts & bolts are preferred fasteners 114 for those embodiments. In other implementations, the adjustment plates comprise two or more crescent shaped plates that can be connected to the bottom-wall to narrow the feeder housing opening around a round or curved feeder housing.

The material of construction for some implementations, such as guard 100, is a durable metal that can be welded. Thus, in those implementations, the components of guard 100 may be attached or connected to one another via welding. In some implementations, the metal is iron of typical commercial composition. In other implementations the metal is a stainless steel. In some implementations, such as guard 100, the sidewall 103 and bottom-wall 107 are constructed from a metal grate also known as “diamond grate,” “diamond mesh,” and more commonly “expanded metal sheet” in the industry.

In some implementations, the guard further comprises a weather resistant coating 119 such as enamel paint, ceramic, rubber, plastic, and the like.

Although the invention has been described and illustrated with a certain degree of detail or with reference to one or more particular implementations, it is understood that the present disclosures have been made only by way of example. It should be understood that the invention is not intended to be limited to the particular forms disclosed. Furthermore, the invention is amenable to various modifications and alternative forms. Obvious variations and other various changes in the composition, combination, and arrangement of parts can be utilized to by those skilled in the art without departing from the spirit and scope of the invention, as herein disclosed and claimed.

1. A guard for protecting a target feed-distributing feed-bin-mounted feeder comprising:
a ring, having a diameter less than a target feed bin holding a target feed with a known maximum granular dimension,
a sidewall, having a top edge, a bottom edge, and a first plurality of small openings,
wherein each of the first plurality of small openings is larger than the target feed maximum granular dimension, and wherein the bottom edge of the sidewall is connected to the ring,
a bottom-wall, having a second plurality of small openings and a feeder housing opening, wherein each of the second plurality of small openings is larger than the target feed maximum granular dimension, further wherein the feeder housing opening is larger than a cross sectional area of the target feeder at a plane formed by the intersection of the bottom-wall and the target feeder, and further wherein the bottom-wall perimeter is connected to the ring,
at least two mounting brackets, wherein the at least two mounting brackets are connected to and evenly distributed along the top edge of the sidewall, and
a bracket fastener for each of the at least two mounting brackets, wherein each bracket fastener engages with each of the at least two mounting brackets.

2. The device of claim 1 further comprising:
a weather resistant coating that substantially covers the guard.

3. The device of claim 1 further comprising:
at least one adjustment plate, wherein each of the at least one adjustment plate is position-able and reversibly connectable to the bottom-wall via at least one adjustment plate fastener for each of the at least one adjustment plate, such that the feeder housing opening is at least partially reduced in a dimension.

4. The device of claim 3 wherein:
the at least one adjustment plate is L-shaped.

5. The device of claim 1 wherein:
the guard is constructed of a metal selected from the group comprising, iron including cast-iron, steel including stainless steel, brass, and aluminum including cast-aluminum.

6. The device of claim 5 wherein:
the metal of construction is an expanded metal.

7. The device of claim 1 wherein:
the bracket fastener is selected from the group comprising screws, nuts & bolts, nails, glue, rivets, self-tapping screws, and self-anchoring bolts.

8. A guard for protecting a target feed-distributing feed-bin-mounted feeder comprising:
a substantially cylindrical ring, having a diameter less than a target feed bin holding a target feed with a known maximum granular dimension,
a substantially cylindrical sidewall, having a top edge, a bottom edge, and a first plurality of small openings, wherein each of the first plurality of small openings is larger than the target feed maximum granular dimension, and wherein the bottom edge of the sidewall is connected to the ring,
a substantially circle-shaped bottom-wall, having a second plurality of small openings and a feeder housing opening, wherein each of the second plurality of small openings is larger than the target feed maximum granular dimension, further wherein the feeder housing opening is larger than a cross sectional area of the target feeder at a plane formed by the intersection of the bottom-wall and the target feeder, and further wherein the bottom-wall perimeter is connected to the ring,
at least three mounting brackets, wherein the at least three mounting brackets are connected to and evenly distributed along the top edge of the sidewall,
a bracket fastener for each of the at least three mounting brackets, wherein each bracket fastener engages with each of the at least three mounting brackets,
a weather resistant coating that substantially covers the guard, and
wherein the sidewall and bottom-wall are constructed of an expanded metal.

9. The device of claim 8 further comprising:
at least one adjustment plate, wherein each of the at least one adjustment plate is position-able and reversibly connectable to the bottom-wall via at least one adjustment plate fastener for each of the at least one adjustment plate, such that the feeder housing opening is at least partially reduced in a dimension.
